(19) United States
(12) Patent Application Publication
(10) Pub. No.: US 2011/0056614 A1
(43) Pub. Date: Mar. 10, 2011

(54) MANUFACTURING METHOD OF CIRCUIT BOARD

(75) Inventors: Jin-Yong AN, Yongin-si (KR); Soon-Oh Jung, Suwon-si (KR); Dong-Ju Jeon, Seoul (KR)

(73) Assignee: SAMSUNG ELECTRO-MECHANICS CO., LTD.

(21) Appl. No.: 12/649,899

(22) Filed: Dec. 30, 2009

(30) Foreign Application Priority Data
Sep. 10, 2009 (KR) 10-2009-0085385

(51) Int. Cl. C25D 11/02; B32B 38/10

(52) U.S. Cl. 156/150; 156/250

(57) ABSTRACT

A manufacturing method of a circuit board is disclosed. The manufacturing method of a circuit board in accordance with the present invention includes forming a separation layer on a carrier, stacking an adhesion layer which is coupled to the carrier and covers the separation layer, forming a circuit layer on the adhesion layer, forming a circuit board unit by cutting the separation layer, the adhesion layer and the circuit layer such that the separation layer is separated from the carrier, and forming a stiffener by processing the separation layer of the circuit board unit. The manufacturing method of a circuit board in accordance with the present invention can reduce the cost and time for forming the stiffener by forming the stiffener together in the manufacturing process of the circuit board.

### CROSS-REFERENCE TO RELATED APPLICATIONS

This application claims the benefit of Korean Patent Application No. 10-2009-0085385 with the Korean Intellectual Property Office on Sep. 10, 2009, the disclosure of which is incorporated herein by reference in its entirety.

### BACKGROUND

1. Technical Field

The present invention relates to a manufacturing method of a circuit board.

2. Description of the Related Art

Recently, the size of electronic components for electronic devices gets smaller. Accordingly, the size of package of a device chip also gets smaller. This requires thinner circuit boards for the package. Meanwhile, to minimize the loop inductance originated by physical distance of circuitry, thinner circuit boards are required.

According to today's trend that circuit boards get thinner, there is an increasing demand for coreless substrates which omit the core in the circuit board.

Since the coreless substrate has a structure of low stiffness, stiffeners are used for reinforcement. Accordingly, because a process for implementing the stiffeners on the circuit board is needed, additional manufacturing cost and time are consumed.

### SUMMARY

The present invention provides a manufacturing method of circuit board that can easily form stiffeners on circuit board.

One aspect of the invention provides a manufacturing method of a circuit board. The manufacturing method of a printed circuit board in accordance with an embodiment of the present invention can include: forming a separation layer on a carrier; stacking an adhesion layer which is coupled to the carrier and covers the separation layer; forming a circuit layer on the adhesion layer; forming a circuit board unit by cutting the separation layer, the adhesion layer and the circuit layer such that the separation layer is separated from the carrier; and forming a stiffener by processing the separation layer of the circuit board unit.

Here, the forming of a separation layer can include stacking a metal plate on the carrier.

The forming of a separation layer can also include forming a demolding layer on the carrier before the stacking of a metal plate.

The method can also include forming a reinforcement layer on the circuit layer and forming a stiffener by processing the reinforcement layer.

The forming of a reinforcement layer can include applying a solder resist on the circuit layer and stacking a metal plate on the solder resist by vacuum lamination.

The method can also include forming a plating protection layer on the stiffener.

The forming of the plating protection layer can include forming an oxidized film on the stiffener.

The forming of the oxidized film can include anodizing the stiffener.

Here, the stiffener can include aluminum, and the anodizing of the stiffener can include forming an aluminum oxide by anodizing the aluminum stiffener.

The forming of a plating protection layer can include forming the plating protection layer by applying an insulation material on the stiffener.

The forming of a plating protection layer can include forming an OSP (Organic Solderability Preservative) coating layer on the stiffener.

Additional aspects and advantages of the present invention will be set forth in part in the description which follows, and in part will be obvious from the description, or may be learned by practice of the invention.

### BRIEF DESCRIPTION OF THE DRAWINGS

FIG. 1 is a flow chart of a manufacturing method of a circuit board according to an embodiment of the invention.

FIG. 2 through FIG. 9 illustrate sectional views showing processes of a manufacturing method of a circuit board according to an embodiment of the invention.

### DETAILED DESCRIPTION

An embodiment of the present invention will be described below in more detail with reference to the accompanying drawings.

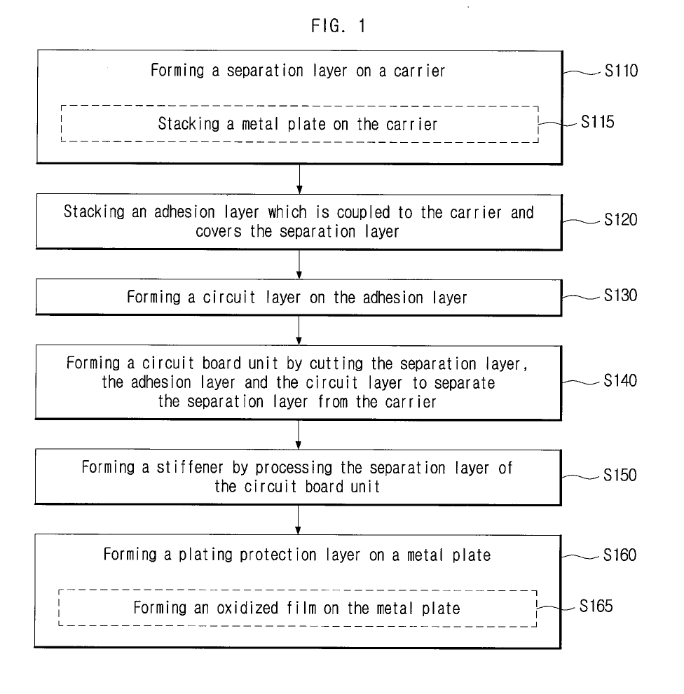

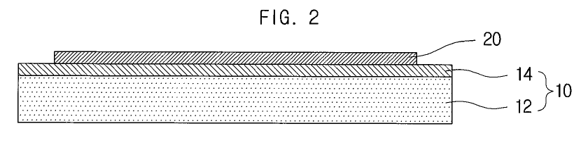

FIG. 1 is a flow chart of a manufacturing method of a circuit board according to an embodiment of the invention, and FIG. 2 through FIG. 9 illustrate sectional views showing processes of a manufacturing method of a circuit board according to an embodiment of the invention.

The manufacturing method of a circuit board in accordance with an embodiment of the present invention includes forming a separation layer (S 110), stacking an adhesion layer (S120), forming a circuit layer (S130), forming a circuit board unit (S140) and forming a stiffener (S150). Also, it can further include forming a plating protection layer (S160)

A separation layer 20 is formed on a carrier 10 in forming a separation layer (S110). The carrier 10 is a part supporting an in-process product of the circuit board in the manufacturing process, and the separation layer 20 is a part which is not connected to the carrier 10 but stacked on the carrier 10 only to easily separate the in-process product of circuit board from the carrier 10.

Here, the carrier 10 can be composed of insulation material. Because the difference in thermal expansion coefficient between the carrier 10 composed of insulation material and the circuit board formed above the carrier 10 is small, the carrier 10 can prevent damages which are resulted from thermal deformation in the process. Also, the carrier 10 can include a metal layer 12. The metal layer costs less and can be recycled with limited damages in a cutting process described below.

Moreover, the separation layer 20 is formed by stacking a metal plate on the carrier 10 (S115). The metal plate used as the separation layer 20 can be easily produced by an etching process in forming a stiffener (S150).

As illustrated in FIG. 2, the carrier 10 which is formed by stacking the metal layer 14 on the insulation layer 12 is used in this embodiment. Also, the separation layer 20 is formed by stacking the metal plate on the metal layer 14 of the carrier 10. Here, for the purpose of easy separation between the metal layer 14 and the metal plate in the separation process of the separation layer described below, a demolding layer can be formed on the carrier 10 before stacking the metal plate constituting the separation layer 20.

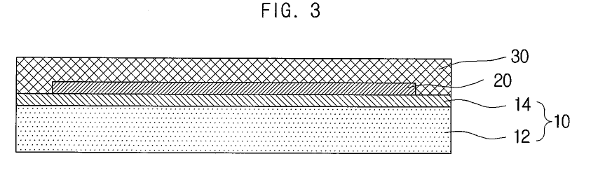

Subsequently, an adhesion layer 30, which is coupled to the carrier 10 and covers the separation layer 20, is stacked on the carrier 10 in stacking the adhesion layer (S120). As illustrates in FIG. 3, the adhesion layer 30, which covers the separation layer 20 and is stacked, is coupled at the area of the carrier 10, which is not covered by the separation layer 20. Accordingly, the in-process product, which is stacked on the separation layer 20 and the adhesion layer 30, is firmly supported by the carrier 10.

In this embodiment, the adhesion layer 30 is formed by applying an insulation material on the carrier 10 on which the separation layer is stacked.

Subsequently, a circuit layer 40 is formed on the adhesion layer 30 in forming a circuit layer (S130).

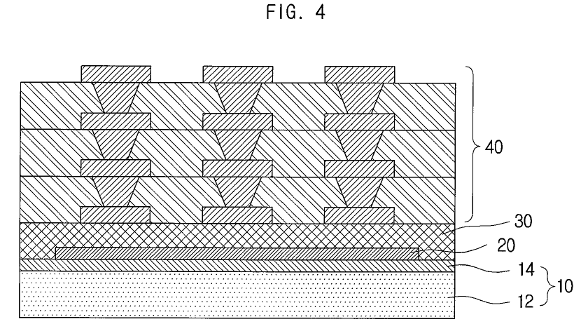

As illustrated in FIG. 4, a multi-layered circuit layer 40 is formed on the insulation layer used as the adhesion layer 30 by using the Build-Up process in this embodiment.

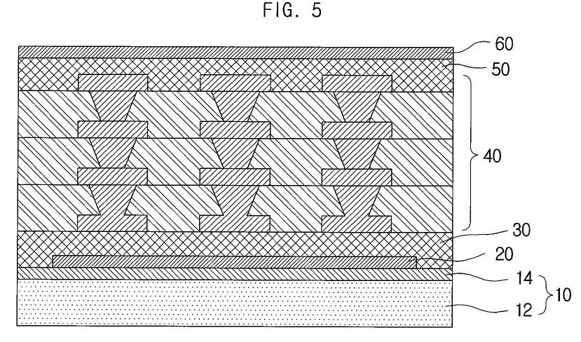

At this time, as illustrated in FIG. 5, a reinforcement layer 60 can be further formed on the circuit layer 40 in order to form stiffeners 25, 26 on both sides of the circuit board. The reinforcement layer 60 can be used as a stiffener 65 in the subsequent process. In this embodiment, the reinforcement layer 60 is formed by stacking a metal plate.

Here, the stack of the reinforcement layer 60 can be formed in company with forming a solder resist layer 50. Specifically, after applying the solder resist on the circuit layer 40, the metal layer can be coupled to the solder resist layer 50 by laminating the metal plate with vacuum press.

Subsequently, a circuit board unit is formed by cutting the separation layer 20, the adhesion layer 30 and the circuit layer 40 to separate the separation layer 20 from the carrier 10 in forming a circuit board unit (S140). Because the carrier 10 is not needed in a finished circuit board, the circuit board unit is formed by separating the circuit layer 40 from the carrier 10 after forming major parts of the circuit board.

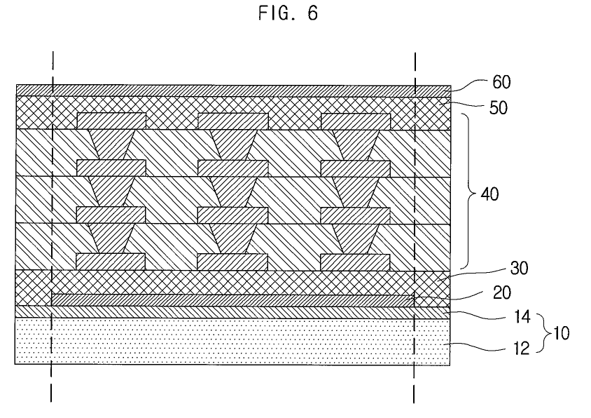

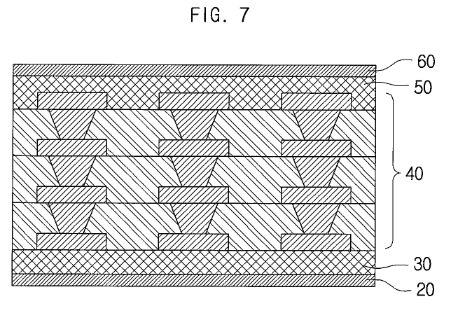

Specifically, the unit of circuit board and carrier 10 are separated by separating the separation layer 20 of the unit of circuit board from the carrier 10. In order to do this, as illustrated in FIG. 6, the separation layer 20 and the adhesion layer 30 and the circuit layer 40, which are formed on the separation layer 20, are cut. Since the carrier 10 and the separation layer 20 are not coupled, as illustrated in FIG. 7, the circuit board unit can be separated from the carrier 10 along the separation layer 20. In this embodiment, the separation layer 20, the adhesion layer 30 and the circuit layer 40, which are stacked on the carrier 10, are cut through a routing process.

Subsequently, a stiffener 25 is formed by processing the separation layer 20 of the circuit board unit and utilizing the separation layer 20 in forming a stiffener (S150). Accordingly, the manufacturing cost and manufacturing time are reduced because the stiffener 25 is formed together in the processing of the circuit board.

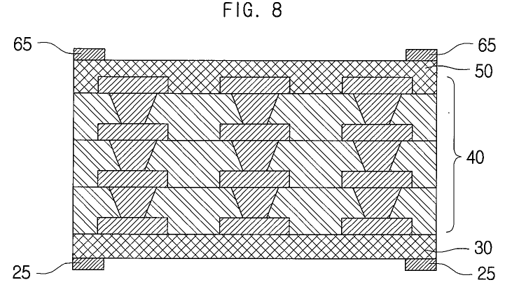

As illustrated in FIG. 8, the stiffener 25 is formed by processing the metal plate used as the separation layer 20 with an etching process in this embodiment. In this time, the stiffeners 25, 65 can be formed on both sides of the circuit board unit together by processing the metal plate used as the reinforcement layer 60 with the etching process.

The stiffeners 25, 65 are formed by processing the metal plate in this embodiment. Accordingly, the waste of the plating plate may occur due to the plating of the expensive plating plate on the stiffeners 25, 65 in the subsequent forming of an electrode pad.

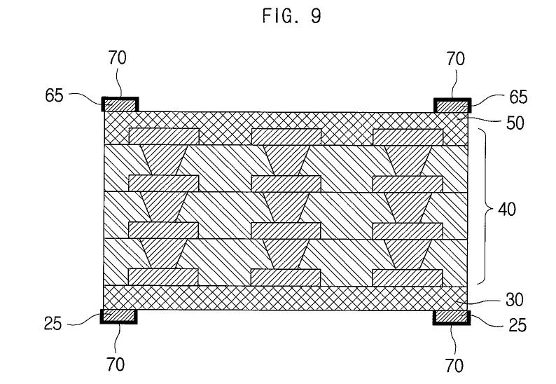

For the purpose of preventing this, as illustrated in FIG. 9, a plating protection layer 70 is formed on the stiffeners 25, 65 in forming a plating protection layer (S160).

Specifically, forming an oxidized film on the stiffeners 25, 65 in this embodiment can prevent plating (S165). Here, the oxidized film can be formed by anodizing, i.e. anodic oxidation. Anodic oxidation is the method that can connect a metal to an anode, which sinks under an electrolyte, and oxidize the surface of the metal by oxygen generated from the anode. Since the oxidized film formed on the surface of the stiffeners 25, 65 by anodic oxidation has lower conductivity, it can prevent the ion of the plating plate from sticking to the stiffeners 25, 65. Moreover, because the oxidized film has high corrosion resistance and high stiffness, it has limited damages in the subsequent manufacturing process of the circuit board.

Especially, in the case of forming the stiffeners 25, 65 made of aluminum by processing the aluminum metal plate, an aluminum oxide is formed by anodizing the aluminum stiffeners 25, 65.

Meanwhile, the plating protection layer 70 can be formed by applying an insulation material, which can prevent plating, to the stiffeners 25, 65, in contrast to this embodiment. Specifically, an OSP (Organic Solderability Preservative) coating layer can be formed on the stiffeners 25, 65.

OSP coating can be readily applied to an automatic production line because of the low cost and is environmentally friendly.

The manufacturing method of a circuit board in accordance with the present invention can provide forming of the stiffener together in the manufacturing of the circuit board, thereby reducing the cost and time for forming the stiffener.

Moreover, the manufacturing method of a circuit board in accordance with the present invention can prevent plating on the stiffener, thereby preventing a wasting of high-priced plating metal.

Hitherto, although a certain embodiment of the present invention have been shown and described for the above-described objects, it will be appreciated by any person of ordinary skill in the art that a large number of modifications, permutations and additions are possible within the principles and spirit of the invention, the scope of which shall be defined by the appended claims and their equivalents.

What is claimed is:

1. A manufacturing method of a circuit board, comprising:
forming a separation layer on a carrier;
stacking an adhesion layer, the adhesion layer being coupled to the carrier and covering the separation layer;
forming a circuit layer on the adhesion layer;
forming a circuit board unit by cutting the separation layer, the adhesion layer and the circuit layer such that the separation layer is separated from the carrier; and
forming a stiffener by processing the separation layer of the circuit board unit.

2. The method of claim 1, wherein the forming of a separation layer comprises stacking a metal plate on the carrier.

3. The method of claim 2, wherein the forming of a separation layer further comprises forming a demolding layer on the carrier before the stacking of a metal plate.

4. The method of claim 1, further comprising:
forming a reinforcement layer on the circuit layer; and
forming a stiffener by processing the reinforcement layer.

5. The method of claim 4, wherein the forming of a reinforcement layer comprises:
applying a solder resist on the circuit layer; and
stacking a metal plate on the solder resist by vacuum lamination.

6. The method of claim 2 further comprising forming a plating protection layer on the stiffener.

7. The method of claim 6, wherein the forming of a plating protection layer comprises forming an oxidized film on the stiffener.

8. The method of claim 7, wherein the forming of an oxidized film comprises anodizing the stiffener.

9. The method of claim 8, wherein the stiffener includes aluminum and the anodizing of the stiffener comprises forming aluminum oxide by anodizing the aluminum stiffener.

10. The method of claim 6, wherein the forming of a plating protection layer comprises forming a plating protection layer by applying an insulation material on the stiffener.

11. The method of claim 10, wherein the forming of a plating protection layer comprises forming an OSP (Organic Solderability Preservative) coating layer on the stiffener.

12. The method of claim 1 further comprising providing a carrier, in which a metal layer is stacked on an insulation layer.
